(19) United States
(12) Patent Application Publication
(10) Pub. No.: US 2011/0093497 A1
(43) Pub. Date: Apr. 21, 2011

(54) Method and System for Data Input

(76) Inventor: Paul C. Poon, San Jose, CA (US)

(21) Appl. No.: 12/906,985

(22) Filed: Oct. 18, 2010

Related U.S. Application Data
(60) Provisional application No. 61/279,147, filed on Oct. 16, 2009.

(51) Int. Cl. G06F 17/30

(52) U.S. Cl. 707/769; 707/E17.014

(57) ABSTRACT

A method and system for inputting text into a computing device utilizing a software application that runs on a computing device. The application, containing a database of language constructs such as words and sentences, displays a virtual keyboard with a set of keys each of which depicts a language construct. Each key press corresponds to the selection of that language construct depicted on the key. The selected language construct is compared to entries in the database to determine data matches of an entry. For each matching entry, the next word, the word immediately following the part that matches an entry, is entered into a list. After going through all the database entries, a word list is thus collected. This word list forms the set of keys of the virtual keyboard, which is then redrawn to reflect the new layout of the virtual keyboard.

### CROSS-REFERENCE TO RELATED APPLICATION

This application claims priority to U.S. provisional patent application No. 61/279,147, filed on Oct. 16, 2009, which is hereby incorporated by reference in its entirety.

### BACKGROUND

1. Field of Invention

This invention relates generally to computer data entry, and more particularly, to a method and system for input text into a computer using a virtual keyboard.

2. Background

With the advent of touch screen computing devices, such as smart phones and netbooks, a new problem arises. These small devices do not lend themselves to the use of the traditional QWERTY keyboard where the keys are constant. Some products include a small physical keyboard, while some use an onscreen display of a virtual keyboard. In either case, traditional touch-typing techniques cannot be used with these non-standard keyboards. Data entry on these small devices is generally reduced to using one or two fingers, instead of the ten fingers in normal typing. In addition, the position of the keys is not standard, so the user cannot locate the keys by memory, and must use eyesight instead. Given these limitations, data entry using a QWERTY keyboard layout is inefficient.

Additionally in predictive data entry mechanisms, when a user enters the word “how”, a number of phrases beginning with “how” are shown to the user, including for example, “how are you”. However, because the number of sentences beginning with “how” is quite large, only a few sentences can be shown. Furthermore, as each next word in the entry is displayed and selected, the list of words contained in the entry is eventually exhausted.

The present invention leverages the computing power and graphical display screen that comes with new computing devices to create a means of data entry that is more efficient than the QWERTY paradigm. The present invention addresses the limitations of existing predictive data entry mechanisms, vastly increasing the number of sentences that can be followed and allows data entry to continue even further across sentences.

### SUMMARY

The present invention provides a method and system for data input using a virtual keyboard. The invention improves the speed of data entry by allowing the user to enter one word at a time instead one letter at a time.

In a first aspect of an embodiment of the present invention, a graphical display of a virtual keyboard is shown to the user. Since the keyboard is virtual, the keys on the keyboard can dynamically change in appearance and meaning. Each key may be designated a meaning of a higher level construct of the language, such as a word or a phrase.

Initially, the virtual keyboard displays a set of keys that represent commonly used words and letters of the alphabet. When the user presses a key, the virtual keyboard will dynamically change to display a different set of keys. This flexibility enables a user to improve the speed at which data is entered.

In a second aspect of an embodiment of this invention, a database of high level language constructs of the selected language is stored and managed. Each database entry is a high level construct of the language, such as a word, phrase or sentence. When the user enters a word using whatever means available, the database is searched to find entries that match the word. A match occurs when a certain commonality exists between the database entry and the user input. In this embodiment, a match occurs when the database entry begins with the same word or words as those that were entered by the user.

When a matching database entry is found, the next word in the entry that follows the matching portion is displayed in the virtual keyboard. In this manner, if the user is entering a sentence that has a corresponding entry in the database, the user will be able to select each word of the sentence from the virtual keyboard one word at a time. This allows a lot of sentences to be constructible within the virtual keyboard mechanism.

In a third aspect of an embodiment of the present invention, a link is associated with each database entry. The link points to words and sentences that may typically follow that database entry in everyday use of the language. The link allows predictive data entry to continue further across sentences and phrases.

In an embodiment of the present invention, for example, the sentence “how are you” is an entry in the database. When the user enters the word “how”, the next word in the matching database entries is shown as a key in the virtual keyboard. Therefore, the word “are” will be displayed on a button face of a key in the virtual keyboard. If the user then selects “are”, one of the keys in the virtual keyboard will change to “you”. In this manner, the user constructs the sentence “how are you” using three key presses on a virtual keyboard.

After the sentence “how are you” is entered, the link that is associated with this matching database entry leads to more data, typically a list of words or sentences. This linked data has been determined to frequently appear after the matching database entry sentence in real life. In this manner, the virtual keyboard continues to modify its keys so as to maximize the probability of displaying a key with the word or phrase the user seeks to enter next. This in turn increases the speed and enhances the ease of data entry within a single sentence and across sentences.

In one embodiment of the invention, a system for data entry comprising a user interface having a graphical display with input facility, a processing unit for executing commands that direct operations of the system, a memory operatively coupled to the processing unit having code stored in the memory and a database of a plurality of database entries, a system bus connecting the user interface to the processing unit and the memory, and the code executing within the processing unit directs the processing unit to provide a virtual keyboard on the graphical display for displaying one or more keys and accepting data entry in the form of a key selection, each key being designated a meaning of a higher level construct of a language and capable of dynamically changing in appearance and meaning. It also provides a searching means to search the database for at least one candidate, wherein a candidate comprises a matching portion having one or more words that match the data entered, said searching means further comprising a first searching means that generates a first list of candidates, each candidate displayed as a key on the virtual keyboard, and a second searching means that generates a second list of candidates from the first list, each candidate of the second list is displayed as a key replacing the first list of candidate keys. It further provides a link object associated to each database entry, said link object pointing to words and sentences that are determined to follow a respective database entry in use of the language, and provides a means for generating a third list of candidates, each candidate comprising a sequence of words or a sentence associated by the link object for continuing the database entry across database entries.

In another embodiment, the invention is a computer implemented method for data entry, the computer comprising a processing unit for executing commands that direct operations of the computer, and memory operatively coupled to the one or more processors, the method comprising the steps of displaying a first set of keys on a virtual keyboard of a user interface, each key represented by a word, receiving a first key selection selected from the first set of keys, generating a first list of candidates in response to the selection of the first key by searching a database of database entries, each candidate of the first list comprising a sequence of words, and displaying the first list of candidates on the virtual keyboard as a second set of keys, wherein each key is represented by the next word following the word of the first key selection. The method further comprises receiving a second key selection selected from the second set of keys, generating a second list of candidates in response to the selection of the second key by searching the database, displaying the second list of candidates on the virtual keyboard as a third set of keys, wherein each key is represented by the next word following the word of the second key selection, and linking each database entry such that each entry points to a text that is calculated to likely follow said database entry, and displaying the linked text as keys on the virtual keyboard.

These and other aspects of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a system diagram of a computing device according to one embodiment of the present invention.

FIG. 2 is front view of the touch screen of a computing device, according to an embodiment of the present invention.

FIG. 3 is a graphical display of the virtual keyboard of a computing device of FIG. 2, according to an embodiment of the present invention.

FIG. 4 is the graphical display of the list of next words of the computing device of FIG. 2, according to an embodiment of the present invention.

### DETAILED DESCRIPTION OF SPECIFIC EMBODIMENTS

The present invention provides a method and system for efficiently inputting data into a device which has the ability to display a graphical screen and computing power to dynamically modify the appearance of the screen according to user action. The following description is presented to enable one of ordinary skill in the art to make and use the invention and is provided in the context of exemplary preferred embodiments. Various modifications to the preferred embodiments will be readily apparent to those skilled in the art and the generic principles defined herein may be applied to other embodiments. Thus, the present invention is not intended to be limited to the embodiments shown herein, but is to be accorded a scope consistent with the principles and features described herein.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Exemplary Computer System for Implementing the Invention

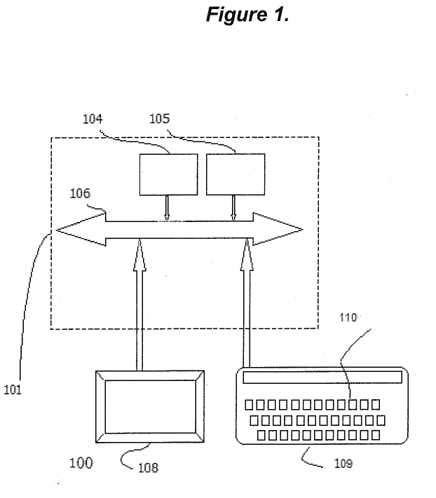

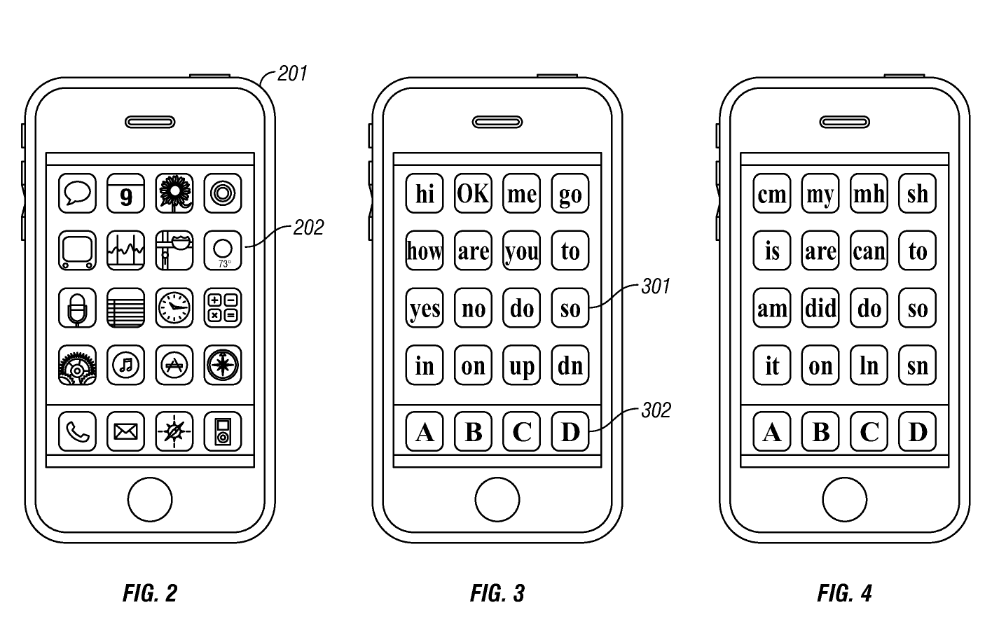

In an exemplary embodiment of the present invention, a computer executable program has incorporated in it, a database of high level language constructs, such as predefined phrases, sentences and arbitrary groups of words. This computer executable program may reside on a computing device with a graphical display sensitive to touch. Embodiments of the invention may be implemented in the computing devices as shown in FIG. 1 and FIG. 2.

An embodiment of the invention may be executed on a computing device in the form of computer-executable instructions, such as program modules. Program modules may include routines, programs, objects, components, data structures, and others as known in the art, that perform particular tasks or implement particular abstract data types. Moreover, those skilled in the art will appreciate that the invention may also be practiced with computer system configurations, including hand-held devices, multiprocessor systems, microprocessor-based or programmable consumer electronics, specialized hardware devices, network processes, minicomputers, mainframe computers, and the like. The invention may also be practiced in distributed computing environments where tasks are performed by remote processing devices that are linked through a communications network. In a distributed computing environment, program modules may be located in both local and remote memory storage devices.

In an embodiment of the present invention, as shown in FIG. 1, the invention may be implemented in a general purpose computing device in the form of a conventional personal computer 101 comprising a processing unit 104 for processing program and/or module instructions, a memory 105 in which the program and/or module instructions may be stored, a system bus 106, and other system components, such as storage devices, which are not shown but will be known to those skilled in the art. The system bus 106 serves to connect various components to processing unit 104, so that the processing unit 104 can act on the data coming from such components, and send data to such components. For example, the system 100 may include a pointing device 108 that is used to detect a selected location on a screen 109. The screen displays a graphical display and the location selected marks a virtual graphical key displayed on the screen 109. The pointing device 108 may be a stand-alone component. It will be understood that the functionality provided may be facilitated by either a hardware device, or a finger touch on a touch sensitive screen 202 as shown in FIG. 2.

System Architecture

In an embodiment, the present invention may be implemented as a computer executable program running on a computing device, for example a personal computer or a hand held device 201. When the user desires to enter textual data into the computer's input stream, the user first activates the computer executable program implementing the invention. Upon activation, a virtual keyboard 110 is displayed on the graphical display with an initial set of keys. In an embodiment of the invention, the virtual keyboard 110 may display a set of keys that represent commonly used words 301 and letters 302 of the alphabet, as shown in FIG. 3. In another embodiment, each key may be designated a meaning of a high level construct of the language, such as a word or a phrase. Keys on the virtual keyboard 110 may dynamically change in appearance and meaning. When the user presses a key, the virtual keyboard 110 will dynamically change to display a different set of keys. This flexibility enables a user to improve the speed at which data is entered. Additionally, the keyboard is dynamically modifiable and may be scrolled to reveal more keys through methods known in the art.

In an embodiment of the invention, incoming key presses on the virtual keyboard 110 are monitored. Keys pressed by the user are read and then translated into the language construct currently represented by the key.

The language construct obtained from the key selection, is then compared against a database of high level language constructs. The database of high level language constructs may include entries such as words, sentences and phrases. When the user inputs a word, using whatever means available, the database is searched to find entries that match the word. A match occurs when a certain commonality exists between the database entry and the user input. In an embodiment, a match occurs when the database entry begins with the same word or words that were entered by the user. If a match is found, then the sentence or phrase is considered a candidate. More specifically, for example, if the user entered the word “how”, sentences in the database beginning with the word “how”, would become a candidate.

In an embodiment of the invention, the user input is compared to each candidate. The word in the candidate that follows the matched portion is then entered into a list of words. More specifically, after the entire database is searched for candidates, a list of words comprising the words following the matched portion of all the candidates in the database, is collected. Each word from the list is now represented by a key on the virtual keyboard 110, and the virtual keyboard 110 is redrawn to reflect that change. The user can then select the next word by pressing the appropriate key on the virtual keyboard 110. In this manner, if the user desires to enter a sentence that has a corresponding entry in the database, the user is able to select each word of the sentence from the virtual keyboard 110 one word at a time.

In an embodiment of the invention, because the keyboard is capable of displaying the words the user wants, the construction of a sentence can be accomplished without typing out words letter by letter as is done on traditional keyboards. In an embodiment of the invention, the virtual keyboard 110 may contain a 4×5 matrix of keys, as shown in FIG. 3. In another embodiment, a virtual keyboard containing 25 keys may, for example, have an associated 25⁵, or 9 million, sentences constructible with a string of 5 words.

In one embodiment of the present invention, for example, the database contains the following entries:

“how are you”

“how are the kids doing”

“how much is it”

The user enters the word “how” and the database is searched for entries beginning with “how”. The above three candidates are subsequently found. The words “are” and “much” are then placed into a list of words as the next word of each candidate following the matched portion “how”.

After the database is searched, the word “how” becomes the output of the data entry operation, and the virtual keyboard is redrawn to display the keys “are” and “much” as shown in FIG. 4. In one embodiment, the “are” key may take the place of the key that was used to represent “how”. In an exemplary embodiment, duplicate next words appearing in more than one candidate are displayed in one key. For example, if “are” appears as the next word in two candidates, only one “are” key will appear on the virtual keyboard.

When the user then selects the “are” key, the database is searched for the words “how are” and the first two entries in the above database are found. Thereafter, the words “you” and “the” are placed into another list of next words. The word “are” is then output, and the virtual keyboard dynamically changes to display a “you” key and a “the” key. This process continues until all candidates are exhausted.

In another embodiment of the invention, if the user wishes to type the sentence “how are you”, the user may type the word “how” using the letter keys 302 on the keyboard. The words “are” and “you” are subsequently displayed in keys and can be entered to complete the sentence with single key presses.

In an embodiment of the present invention, a link object is associated with each database entry. A link object may point to more data. The data may be a sentence, a group of sentences, a certain computer function, or a collection of words. In an embodiment, the link object points to words and sentences that may typically follow that database entry in everyday use of the language. In an embodiment, the link object associates the sentence entered with text that may likely follow the sentence. It enables text or words that may likely follow the inputted sentence to appear as next word keys in the virtual keyboard.

In the example above, the virtual keyboard keys are determined by the next word of each candidate. At the end of a sentence, there may be no more next words. The link object enables a different list of words to be provided that will likely follow the sentence. For example, keys containing the first words of a group or words or a sentence that would likely follow “how are you” are displayed. In this manner, the virtual keyboard continues to provide useful keys to continue the data entry across sentences.

The link object may take many different forms, such as a pointer to a data structure or to a software function that does certain computations. In one embodiment, the link object may be an index to an array. For example, each element of an array may be a collection of sentences or a list of unrelated words. In one embodiment, the link object may be an index to an array, each element of which is a collection of words.

In an embodiment of the invention, when all the words in a candidate have matched the user input, there is no more next word that can come from that candidate. Instead, the link object is fetched from the candidate. The collection of words is fetched from the array using the link object as the array index, and all the words in the collections of words are placed into a list of words that forms the next word keys of the virtual keyboard. This enables the user the ability to continue choosing words when entering text comprising multiple sentences.

In another embodiment of the invention, as the user presses buttons to select words to construct a sentence, the words are output one at a time and the virtual keyboard is updated to show all the next words of the matched entries as virtual keys.

In this embodiment, there may be one or more database entries that completely match the sequence of words input by the user, and a number of database entries that partially match the user input. Therefore, the next set of virtual keys displayed in the virtual keyboard, are a combination of the next words coming from the partially matched candidates and the words that come from the links of the database entries that are complete matches.

For example, the database may contain these entries:

Entry 1: “how are you”, link 1

Entry 2: “how are you doing”, link 2

Link 1: “and”, “I”

Link 2: “hope”, “is”

In this embodiment, the user selects the “how” key from the initial screen and the virtual keyboard displays an “are” key, which is the next word of the two matches from Entry 1 and Entry 2. After the “are” key is selected, the virtual keyboard displays a “you” key, the next word after “how” and “are”.

After the “you” key is selected, Entry 1 is a total match, and there is no more next word. Thereafter, the link is fetched, providing “and” and “I” keys, which will be shown as virtual keys. At the same time, Entry 2 is still a partial match, yielding a next word of “doing”. Therefore, the virtual keyboard will display the keys “and”, “I”, and “doing”.

In another embodiment of the invention, there may be these two sentences in the database:

“The economy this year is good”

“The economy this year is bad”

So, the keys “The”, “economy”, “this”, “year”, “is” appear in a series of screen updates as the user presses the sequence of keys above one after the other to form a sentence. When the virtual keyboard refreshes after the “is” key, the keys “good” and “bad” are displayed. After either the “good” or “bad” key is selected, there are no more next words for the two database entries. The associated links to each entry then points to more data.

In another embodiment, the phrase “The economy” is also an entry of the above database example. After two key selections of “The” and “economy”, a third key displaying “this” appears. In this embodiment, the database entry “The economy” is already exhausted and has no more next word. The link associated with this entry is then fetched. This link then specifies a list of two words, such as “is” and “sucks”. The virtual keyboard will then refresh to display the keys “is”, “suck” and “this”.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description.

I claim:

1. A system for data entry comprising:
a user interface having a graphical display with input facility;
a processing unit for executing commands that direct operations of the system;
a memory operatively coupled to the processing unit having code stored in the memory and a database of a plurality of database entries;
a system bus connecting the user interface to the processing unit and the memory;
and the code executing within the processing unit directs the processing unit to:
provide a virtual keyboard on the graphical display for displaying one or more keys and accepting data entry in the form of a key selection, each key being designated a meaning of a higher level construct of a language and capable of dynamically changing in appearance and meaning;
provide a searching means to search the database for at least one candidate, wherein a candidate comprises a matching portion having one or more words that match the data entered,
said searching means further comprising a first searching means that generates a first list of candidates, each candidate displayed as a key on the virtual keyboard, and a second searching means that generates a second list of candidates from the first list, each candidate of the second list is displayed as a key replacing the first list of candidate keys;
provide a link object associated to each database entry, said link object pointing to words and sentences that are determined to follow a respective database entry in use of the language; and
provide a means for generating a third list of candidates, each candidate comprising a sequence of words or a sentence associated by the link object for continuing the database entry across database entries.

2. The system of claim 1, wherein each database entry comprises of a group of words, a phrase or a sentence.

3. The system of claim 2, wherein each candidate from the first list contains the matching portion from a first data entry.

4. The system of claim 3, wherein each candidate from the second list contains the matching portion from the first data entry and a second data entry.

5. The system of claim 4, wherein the keys displaying the first list of candidates are represented by a next word following the matching portion of the first data entry.

6. The system of claim 5, wherein the keys displaying the second list of candidates are represented by a next word following the matching portion from the first data entry and the second data entry.

7. The system of claim 6, wherein the virtual keyboard contains a four by five matrix of keys or at least twenty-five keys.

8. The system of claim 6, wherein the third list of candidates is displayed as a plurality of keys, each key representing a first word of each sequence of words or sentence.

9. The system of claim 8, wherein each candidate in the third list of candidates is determined to most likely follow the database entry in the language use.

10. A computer implemented method for data entry, the computer comprising a processing unit for executing commands that direct operations of the computer, and memory operatively coupled to the one or more processors, the method comprising the steps of:
displaying a first set of keys on a virtual keyboard of a user interface, each key represented by a word;
receiving a first key selection selected from the first set of keys;
generating a first list of candidates in response to the selection of the first key by searching a database of database entries, each candidate of the first list comprising a sequence of words;
displaying the first list of candidates on the virtual keyboard as a second set of keys, wherein each key is represented by the next word following the word of the first key selection;
receiving a second key selection selected from the second set of keys;
generating a second list of candidates in response to the selection of the second key by searching the database;
displaying the second list of candidates on the virtual keyboard as a third set of keys, wherein each key is represented by the next word following the word of the second key selection;
linking each database entry such that each entry points to a text that is calculated to likely follow said database entry, and displaying the linked text as keys on the virtual keyboard.

11. The method of claim 10, wherein database entries comprise a group of words, a phrase or a sentence.

12. The method of claim 11, further comprising the steps of outputting the word from the first key selection, receiving the selection from the second set of keys, and outputting the word from second key selection.

13. The method of claim 10, wherein the link further associates a sentence entered with text that is determined to likely follow the sentence.

14. The method of claim 13, wherein the link enables text or words that are calculated to likely follow the entered sentence to appear as keys on the virtual keyboard.

15. The method of claim 11, wherein the step of generating a first list of candidates further comprises matching the first key selection to each database entry, each database entry comprising of a group of words, a phrase or a sentence.

16. The method of claim 14, wherein the step of generating a first list of candidates further comprises matching the first key selection to each database entry, each database entry comprising of a group of words, a phrase or a sentence.

17. The method of claim 15, wherein the step of generating a second list of candidates further comprises matching the words of the first and second key selections to each database entry.

18. The method of claim 16, wherein the step of generating a second list of candidates further comprises matching the words of the first and second key selections to each database entry.

19. The method according to claim 10, further comprising repeating the steps of receiving a key selection, generating a list of candidates and displaying a list of candidates on the virtual keyboard with respect to a next set of keys.
